(19) United States
(12) Patent Application Publication
(10) Pub. No.: US 2021/0341308 A1
(43) Pub. Date: Nov. 4, 2021

(54) GLOBAL MAP CREATION USING FLEET TRAJECTORIES AND OBSERVATIONS

(71) Applicant: Harman Becker Automotive Systems GmbH, Karlsbad (DE)

(72) Inventors: Volodymyr IVANOV, Munich (DE); Eric THEISINGER, Munich (DE); Tobias Herbert Johannes EMRICH, Munich (DE)

(73) Assignee: Harman Becker Automotive Systems GmbH, Karlsbad (DE)

(21) Appl. No.: 17/286,575

(22) PCT Filed: Oct. 19, 2018
(86) PCT No.: PCT/EP2018/078780

§ 371 Date: Apr. 19, 2021

(51) Int. Cl. G01C 21/00; G06K 9/00

(52) U.S. Cl. CPC G01C 21/3859; G01C 21/3811; G06K 9/00805; G01C 21/3837

(57) ABSTRACT

A method and system for updating or generating global maps are described, the system adapted to perform the steps of obtaining sensor data from one or more sensors of a vehicle, the sensor data describing a plurality of objects within an area surrounding the vehicle at a time or during a time interval; generating a local map based on the sensor data, the local map indicating relative positions of at least some of the plurality of objects to each other, and indicating an absolute position of one or more of the at least some of the plurality of objects; comparing the local map with a global map; updating the global map or generating a new global map based on the comparison.

### CROSS-REFERENCE TO RELATED APPLICATION

This application is the U.S. national phase of PCT Application No. PCT/EP2018/078780 filed on Oct. 19, 2018, the disclosure of which is incorporated in its entirety by reference herein.

### BACKGROUND

Automated driving vehicles require map data that provide additional content compared to existing navigation maps, mainly in the area of the road model description (geometric information), road or driving condition information, and localization objects. The required map data further need to provide high global and relative accuracy and should always be up-to-date. Maps that meet the before mentioned requirements are sometimes referred to as high definition (HD) maps.

Besides this, vehicles with increased sensor capabilities, global navigation satellite systems (GNSS) or inertial measurement units (IMU) utilize information from HD maps as long-range sensor information. Thus, HD maps data further need to provide a confidence value along with the provided data.

Existing map creation approaches do not fulfil those requirements. On the one hand, there are approaches that utilize mobile mapping vans that collect high precise data that go through a long-lasting processing chain. Those approaches do not match the requirement of scaling towards the overall road network, while being up to date. On the other hand, existing crowd sourcing approaches to improve the road network can provide up-to-date information, but suffer from several shortcomings: Some approaches only rely on trajectory data, ignoring additional sensor information available. Others do require specific sensor and data processing technologies, which restricts the numbers of exchange participants. In doing so, these approaches waive crucial information that is essential to create maps with a sufficiently high accuracy for autonomous driving.

### SUMMARY

According to one of many embodiments, there is provided a computer-implemented method of updating or generating global maps. The method comprising: obtaining sensor data from one or more sensors of a vehicle, the sensor data describing a plurality of objects within an area surrounding the vehicle at a time or during a time interval. The method further comprises generating a local map based on the sensor data, the local map indicating relative positions of at least some of the plurality of objects to each other and indicating an absolute position of one or more of the at least some of the plurality of object. The method further comprises comparing the local map with a global map; and updating the global map or generating a new global map based on the comparison.

The above defined method is based on the realization that the accuracy of relative positions of detected objects directly determined on the basis of sensor data is significantly higher than the accuracy of the relative positions determined by global (absolute) positions of the respective objects.

According to an embodiment, the sensor data is obtained by an apparatus arranged at, in particular integrated in the vehicle, the local map is generated by the apparatus, the local map is compared to the global map by a server and the global map is updated or the new global map is generated by the server, the method further comprising: receiving, by the server, the local map generated by the apparatus.

This enables the vehicle to send map representation instead of passing large sets of data. In particular, information on the sensors, such as the sensor setup or sensor specifications do not need to be received by the server. Moreover, information on the local map creation process is not necessarily required by the server. Thereby, the amount of data to be transferred is increased and, consequently, the updating process is accelerated.

According to an embodiment, the method further comprises generating a combined local map based on a first local map and a second local map, wherein an absolute and/or relative position of at least one common object is indicated in the first local map and the second local map, wherein updating the global map or generating a new global map is based on a comparison of the combined local map with the global map.

Each local map is an independent observation result. Combing different local maps indicating the position of the same object increases the accuracy of the object's position and, therefore, increases the accuracy of the global map.

According to an embodiment, the first local map is generated based on sensor data obtained from one or more sensors of a first vehicle and the second local map is generated based on sensor data obtained from one or more sensors of a second vehicle, in particular wherein the first local map is received from a first apparatus arranged in the first vehicle and the second local map is received from a second apparatus arranged in the second vehicle.

Different sensor sets of vehicle variants lead to different perceptions of the surrounding of the vehicle. Thus, considering independent local maps obtained from different vehicles may increase the number of detected objects as well as the accuracy of their determined location.

According to an embodiment, the method further comprises determining a local map accuracy of the local map, wherein updating the global map or generating the new global map is performed if the determined local map accuracy is above a threshold.

The global map accuracy depends on various variables associated with the generation of the local map, such as sensor quality or generation algorithms, that varies for different vehicles. Taking into consideration individual local map accuracies, i.e., confidence indicators, thus leads to a more accurate determination of the global map accuracy. Threshold can be predetermined, or local map accuracy must be higher than global map accuracy.

According to an embodiment, generating a combined local map comprises performing a weighted combination of the first and second local maps based on a determined first accuracy of the first local map and a determined second accuracy of the second local map, and wherein generating or updating the global map comprises updating the global accuracy based on the first accuracy and the second accuracy.

The local map providing the highest accuracy thereby contributes most to the combined local map which results in an increased global map accuracy.

According to an embodiment, determining the local map accuracy comprises: obtaining reference sensor data from the one or more sensors, the reference sensor data describing a plurality of reference objects within a reference area surrounding the vehicle at another time or during another time interval; generating a reference local map of the reference area based on the reference sensor data, the reference local map indicating relative positions of at least some of the plurality of reference objects to each other, and indicating an absolute position of one or more of the at least some of the plurality of reference objects; and comparing the reference local map with reference data associated with the reference area.

Each vehicle may pass defined reference areas within which the global position of detectable objects as well as their relative positions to each other are well known, i.e. for which reference data, such as ground truth data, is available. Comparing local maps generated in said reference areas allows for a consistent and unified assessment of the accuracy of all local maps created on the basis of sensor data obtained in different areas.

According to an embodiment, the local map accuracy is determined repeatedly, in particular periodically.

The repeated or periodic determination of local map accuracies generated by a certain vehicle enables the detection of accuracy changes over lifetime of the vehicle, which allows to reevaluate the accuracy of local maps created on the basis of sensor data obtained from vehicles of the same type that have not passed a reference area for a predetermined time interval.

According to another embodiments, an apparatus is provided. The apparatus comprising a processor adapted to: receive sensor data from one or more sensors of a vehicle, the sensor data describing a plurality of objects within an area surrounding the vehicle at a time or during a time interval; generate a local map based on the sensor data, the local map indicating relative positions of at least some of the plurality of objects to each other, and indicating an absolute position of at least one of the at least some of the plurality of objects. The processor being further adapted to transmit the local map to a server.

According to one embodiment, the apparatus is arranged at, in particular integrated in a vehicle.

According to yet another embodiment, a server is provided. The server is adapted to: receive the local map from an apparatus according to one of the embodiments described above; compare the received local map with a global map; and update the global map or generate a new global map based on the comparison.

### BRIEF DESCRIPTION OF THE DRAWINGS

The present invention may be better understood from reading the following description of non-limiting embodiments, with reference to the attached drawings, wherein:

FIG. 1 shows a system comprising a server being wirelessly connected to vehicles of a vehicle fleet;

FIG. 2 shows a system comprising a server, vehicles of a vehicle fleet, and a map creator being coupled to the server and the vehicles;

FIG. 3 shows a flowchart illustrating a method for global map creation using fleet trajectories and observations; and

FIG. 4 shows a flowchart illustrating a method of determining the accuracy of a local map generated with sensor data obtained from a vehicle.

### DETAILED DESCRIPTION

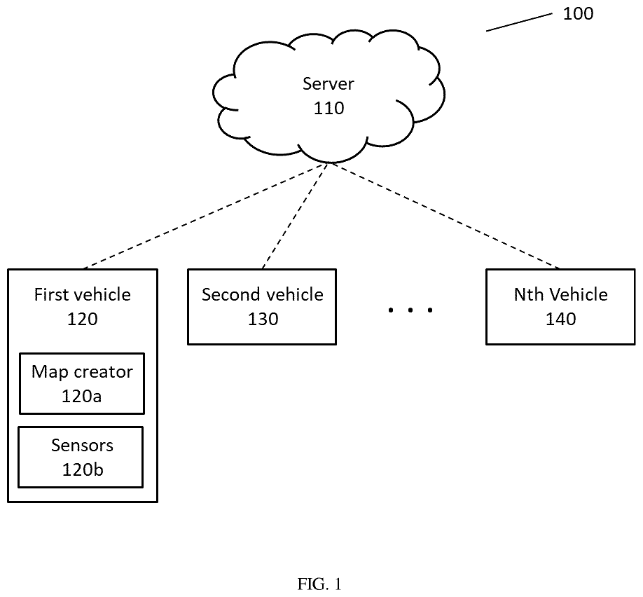

FIG. 1 shows a system 100 comprising a server 110 wirelessly connected to vehicles of a vehicle fleet including a first vehicle 120, a second vehicle 130 and an Nth vehicle 140. The server 110 may be a physical or virtual server, such as a cloud server. The vehicles 120, 130 and 140 may be regular vehicles, or automated driving vehicles and may each comprise a map creator and one or more sensors.

The term “map creator” is used herein to describe data processing techniques adapted to electronically generate a map based on input data from sensors.

The sensors may comprise cameras, lidars, radars or any other sensor suitable for detecting objects in the surrounding of the respective vehicle. FIG. 1 exemplarily shows a map creator 120a and sensors 120b integrated in the first vehicle 120.

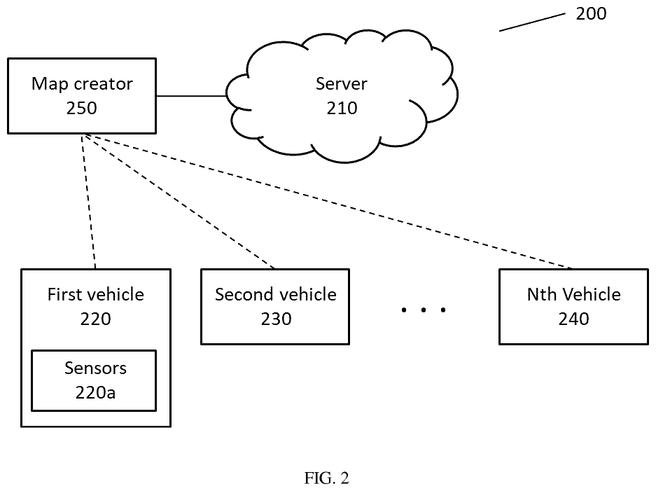

FIG. 2 shows a system 200 comprising a server 210 and vehicles of a vehicle fleet including a first vehicle 220, a second vehicle 230 and an Nth vehicle 240. The server 210 may be a physical or virtual server, such as a cloud server. The vehicles 220, 230 and 240 may be regular vehicles or automated driving vehicles and may each comprise one or more sensors. Exemplarily, sensors 220a integrated in the first vehicle 220 are shown. The sensors 220a are similar to the sensors 120b shown in FIG. 1. The system 200 further comprises a map creator 250 coupled to, for example wirelessly connected to, the server 210. The map creator 250 may wirelessly receive sensor data from the sensors 220a. The map creator 250 may also be wirelessly connected to other vehicles of the vehicle fleet, such as the second vehicle 230 or the Nth vehicle 240 and wirelessly receive sensor data from those other vehicles. In another embodiment, the map creator 250 may be comprised by a server, e.g. by the server 210.

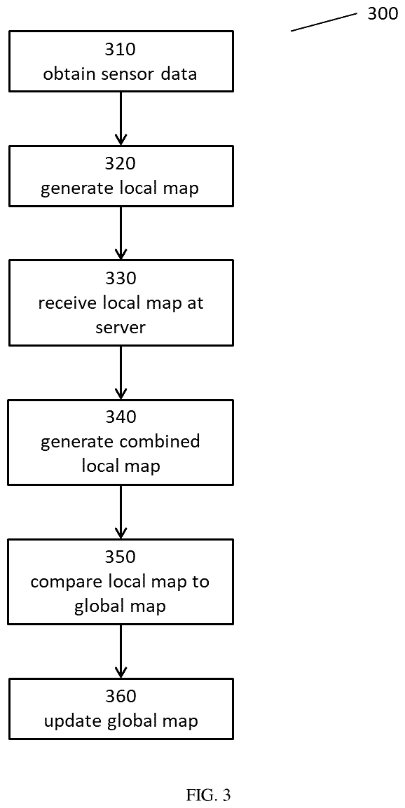

FIG. 3 is a flowchart illustrating a method 300 for global map creation using fleet trajectories and observations. In the following, the method 300 is described to be performed by the system 100, but may similarly be performed by other system, such as the system 200 shown in FIG. 2.

In step 310, the map creator 120a receives sensor data from the sensors 120b. The sensor data describe the environment surrounding the first vehicle 120. More precisely, the sensor data describe objects within the environment surrounding the first vehicle 120. The sensor data are created by the sensors 120b during a certain point in time or a certain period of time. The sensor data thus may provide an aggregated description over time of the environment surrounding the vehicle 120.

After receiving a threshold amount of sensor data or after receiving sensor data during a predetermined time period, the map creator 120a uses, in step 320, the received sensor data to generate a local map. The local map describes the environment of the first vehicle 120 at any point in time within the certain time period. More precisely, the local map may describe relevant objects for map creation that have been detected by the sensors. Relevant objects for map creation may comprise lane markings, landmarks or traffic signs including their respective type, position and three-dimensional shape. The map creator 120a may aggregate sensor data created by the sensors at different points in time. The local map may thus constitute an aggregated representation of detected and relevant objects relative to the vehicle trajectory.

The map creator 120a may use the received sensor data to indicate relative positions between the detected objects within the local map. The local map may further include information about the absolute position of at least one of the objects described in the local map. The map creator 120a uses, for example, global positioning system (GPS) data received from a GPS device comprised by the sensors 120b.

The map creator 120a may send the generated local map to the server 110. With reference to the system 200 described in FIG. 2, the map creator 250 may send a plurality of local maps to the server 210, each of the local maps being generated based on sensor data received from a respective different vehicle, for example, from the second vehicle 230 and the Nth vehicle 240. The map creator 120a may send the local map at a predetermined time, for example, the time when the first vehicle 120 is shut down or after the first vehicle 120 left a predetermined area, i.e., some of the relevant objects are no longer detectable by the sensors 120b. In step 330, the server 110 receives the local map generated by the map creator 120a. In an alternative embodiment, the server 110 may directly receive sensor data from the sensors 120b and generate local maps as described with reference to the map creator 120a.

The server 110 may obtain only one local map or a plurality of local maps generated on the basis of sensor data obtained from one vehicle or from respective different vehicles of the vehicle fleet. The server 110 may receive the plurality of local maps over a predetermined period of time or until a predetermined number of local maps have been received for a defined region.

If the server 110 has received a plurality of local maps, wherein the respective areas described by the local maps may at least partly overlap, the server 110 initiates, in step 340, a merging algorithm to generate a combined local map using the plurality of local maps. The plurality of local maps is received from a single vehicle or from different vehicles, such as from the first vehicle 120 and the second vehicle 130 shown in FIG. 1. The plurality of local maps is combined to provide a single consistent map. This may be done by identifying common objects within the local maps, such as traffic signs, line detections, trees or buildings, and using these common objects to connect the local maps. Subsequently, optimisation steps may be performed in order to position the objects within the combined local map yielding maximal conformance with each of the plurality of local maps. This process may be fully probabilistic. In this regard, a consistent local map may be generated containing metadata such as probabilistic guarantees and confidence indicators. In other words, the accuracy of the combined local map may be determined on the basis of the accuracies of the local maps. Stated in yet another way, the combined local map may represent a weighted combination of a plurality of local maps, wherein the information provided by each local map may be weighted according to the accuracy of the respective local map.

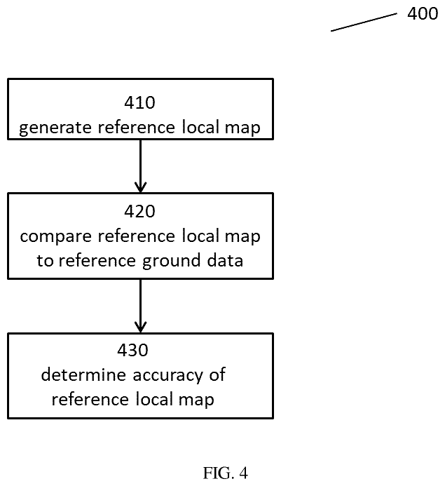

Confidence or accuracy values associated with each local map may be determined based on specifications provided by the vehicle or sensor manufacturer, such as sensor ranges, resolution, accuracy or other functional specification for object detection as well quality indicators of algorithms used by the map creators of the respective vehicles. Alternatively, or in addition, the quality, i.e., accuracy of local maps generated by different vehicles may be determined by a method using reference areas, as described with reference to FIG. 4.

In step 350, the server 110 compares the local map generated by the first vehicle 120 or the combined local map with a pre-existent global map. Within step 350, the server 110 may determine whether the difference between the local map or the combined local map and the respective region of the global map is negligible, i.e., whether the local map or the combined local map is consistent with the global map. The difference may be negligible if, for example, the global map describes the same objects as the combined local map and the relative and absolute positions of the objects comprised in the combined local map are consistent with the respective relative and absolute positions of the objects comprised in the global map within a predetermined range. The server 110 may further determine whether the accuracy of the local map or the combined local map exceeds a threshold value, for example, whether the accuracy of the local map or the combined local map is higher than the accuracy of respective region of the global map.

Subsequently, in step 360, the server 110 updates the global map. The server 110 may, for example, either update the confidence of the global map or replace the respective region of the global map by the local map or the combined local map. If the difference is negligible, the confidence of the global map may be updated, i.e., the accuracy or confidence values associated with positions of objects comprised in the global map may be updated.

If, however, there are significant differences between the combined local map and the respective region of the global map, and the accuracy, i.e., the precision of the local map or the combined local map is high enough, the respective region of the global map may be updated by integrating the combined local map into the global map.

Integrating of the combined local map into the global map may comprise, for example, identifying differing areas within the two maps, launching a merging process to compile a new global map version and to keep the map fully consistent, and updating the new global map version in safety storage like atomic operation to avoid inconsistency during writing/reading processes in parallel.

FIG. 4 shows a flowchart illustrating a method 400 of determining the accuracy of a local map using reference areas. Reference areas may be predetermined areas in which the absolute and relative positions of detectable objects, in particular relevant objects, are well known, i.e., in which the respective positions of the objects have been accurately determined, e.g. during the collection of ground truth data. Each local map may comprise accuracy information. Alternatively, or in addition, each local map may comprise information about the vehicle by which it has been generated, such as a vehicle identification, to allow for an assignment of accuracy information to the generated local map. In the following, the method 400 is described to be performed by the system 100, but may similarly be performed by other system, such as the system 200.

In step 410, the map creator 120a generates a reference local map of at least a part of a reference area using sensor data obtained from the first vehicle 120. In step 420, the map creator 120a or the server 110 compares the generated reference local map to available reference data, for example, ground truth data of the respective reference area. In step 430, the accuracy of the generated reference local map is determined based on the comparison of step 430. The accuracy of the reference local map may be extrapolated towards other areas. In other words, accuracies or confidence values associated with the reference area may be used to determine accuracies or confidence values associated with other local maps generated by the same vehicle or the same vehicle type. Reference areas may not necessarily be closed test tracks, but also public road areas around the globe, such that many vehicles or vehicle types can pass these areas.

Based on the comparison of reference local maps generated using sensor data obtained from one or more vehicles of the same vehicle type with respective reference data, an average or weighted accuracy associated with the respective vehicle or vehicle type may be determined. Thereby, subjective estimations of the local the creation, based on the quality of sensors or sensor data processing algorithms of specific vehicle types, can be compensated. Further, outliers within one vehicle type may be detected and sorted out. In other words, local maps created by different vehicles or vehicle types within a vehicle fleet may be weighted with respect to their accuracy. Or, with reference to the system 200 shown in FIG. 2, local maps created on the basis of sensor data received from different vehicles or vehicle types within a vehicle fleet may be weighted with respect to their accuracy.

The average accuracy associated with the respective vehicle or vehicle type may also depend on different periods of time, such seasons or times of day. The average accuracy may further depend on different weather conditions or traffic situations.

Reference local maps may be generated repeatedly to detect deviations within one vehicle or one vehicle type. These deviations may be caused for example by production accuracies or changes over lifetime of the vehicle or the vehicle type, such as changes caused by small accidences. A variance for a vehicle or a vehicle type may be determined, which allows for a more accurate determination of vehicle or vehicle type accuracies. The accuracy determined for a specific vehicle or vehicle type may also be used to estimate the accuracy of similar vehicles or similar vehicle types for which the accuracy may be unknown or for which the accuracy may not have been determined for a predetermined amount of time.

1. A computer-implemented method of updating or generating global maps, the method comprising:
obtaining sensor data from one or more sensors of a vehicle, the sensor data describing a plurality of objects within an area surrounding the vehicle at a time or during a time interval;
generating a local map based on the sensor data, the local map indicating relative positions of at least some of the plurality of objects to each other, and indicating an absolute position of one or more of the at least some of the plurality of objects;
comparing the local map with a global map; and
updating the global map or generating a new global map based on the comparison.

2. The computer-implemented method of claim 1, wherein the sensor data is obtained by an apparatus arranged at, in particular integrated in the vehicle, the local map is generated by the apparatus, the local map is compared to the global map by a server and the global map is updated or the new global map is generated by the server, the method further comprising:
receiving, by the server, the local map generated by the apparatus.

3. The computer-implemented method of claim 1 further comprising:
generating a combined local map based on a first local map and a second local map, wherein an absolute and/or relative position of at least one common object is indicated in the first local map and the second local map, wherein updating the global map or generating a new global map is based on a comparison of the combined local map with the global map.

4. The computer-implemented method of claim 3, wherein the first local map is generated based on sensor data obtained from one or more sensors of a first vehicle and the second local map is generated based on sensor data obtained from one or more sensors of a second vehicle, in particular wherein the first local map is received from a first apparatus arranged in the first vehicle and the second local map is received from a second apparatus arranged in the second vehicle.

5. The computer-implemented method of claim 1, further comprising
determining a local map accuracy of the local map, wherein updating the global map or generating the new global map is performed if the determined local map accuracy is above a threshold.

6. The computer-implemented method of claim 5, wherein generating a combined local map comprises performing a weighted combination of a first local map and a second local map based on a determined first accuracy of the first local map and a determined second accuracy of the second local map, and wherein generating or updating the global map comprises updating the global accuracy based on the first accuracy and the second accuracy.

7. The computer-implemented method of claim 5, wherein determining the local map accuracy comprises:
obtaining reference sensor data from the one or more sensors, the reference sensor data describing a plurality of reference objects within a reference area surrounding the vehicle at another time or during another time interval;
generating a reference local map of the reference area based on the reference sensor data, the reference local map indicating relative positions of at least some of the plurality of reference objects to each other, and indicating an absolute position of one or more of the at least some of the plurality of reference objects; and
comparing the reference local map with reference data associated with the reference area.

8. The computer-implemented method of claim 5, wherein the local map accuracy is determined repeatedly, in particular periodically.

9. An apparatus comprising:
a processor adapted to:
receive sensor data from one or more sensors of a vehicle, the sensor data describing a plurality of objects within an area surrounding the vehicle at a time or during a time interval;
generate a local map based on the sensor data, the local map indicating relative positions of at least some of the plurality of objects to each other, and indicating an absolute position of at least one of the at least some of the plurality of objects; and
transmit the local map to a server.

10. The apparatus of claim 9 being arranged at, in particular integrated in a vehicle.

11. A server adapted to:
receive the local map from the apparatus of claim 9;
compare the received local map with a global map; and
update the global map or generate a new global map based on the comparison.

12. A method for generating global maps, the method comprising:
obtaining sensor data from one or more sensors of a vehicle, the sensor data describing a plurality of objects within an area surrounding the vehicle at a time or during a time interval;
generating a local map based on the sensor data, the local map being indicative of relative positions of at least some of the plurality of objects to each other and an absolute position of one or more of the at least some of the plurality of objects;
comparing the local map with a global map; and
generating a new global map based on the comparison.

13. The method of claim 12, wherein the sensor data is obtained by an apparatus arranged at, in particular integrated in the vehicle, the local map is generated by the apparatus, the local map is compared to the global map by a server and the global map is updated or the new global map is generated by the server, the method further comprising:
receiving, by the server, the local map generated by the apparatus.

14. The method of claim 12 further comprising:
generating a combined local map based on a first local map and a second local map, wherein an absolute and/or relative position of at least one common object is indicated in the first local map and the second local map, wherein generating the new global map is based on a comparison of the combined local map with the global map.

15. The method of claim 14, wherein the first local map is generated based on sensor data obtained from one or more sensors of a first vehicle and the second local map is generated based on sensor data obtained from one or more sensors of a second vehicle, in particular wherein the first local map is received from a first apparatus arranged in the first vehicle and the second local map is received from a second apparatus arranged in the second vehicle.

16. The method of claim 12 further comprising determining a local map accuracy of the local map, wherein generating the new global map is performed if the determined local map accuracy is above a threshold.

17. The method of claim 16, wherein generating the combined local map comprises performing a weighted combination of a first local map and a second local map based on a determined first accuracy of the first local map and a determined second accuracy of the second local map, and wherein generating the new global map comprises updating the global accuracy based on the first accuracy and the second accuracy.

18. The method of claim 16, wherein determining the local map accuracy comprises:
obtaining reference sensor data from the one or more sensors, the reference sensor data describing a plurality of reference objects within a reference area surrounding the vehicle at another time or during another time interval;
generating a reference local map of the reference area based on the reference sensor data, the reference local map indicating relative positions of at least some of the plurality of reference objects to each other, and indicating an absolute position of one or more of the at least some of the plurality of reference objects; and
comparing the reference local map with reference data associated with the reference area.

19. The method of claim 16, wherein the local map accuracy is determined repeatedly, in particular periodically.
